(19) United States
(12) Patent Application Publication
(10) Pub. No.: US 2025/0139216 A1
(43) Pub. Date: May 1, 2025

(54) PHYSIOLOGICAL INFORMATION PROCESSING SYSTEM AND RELAY DEVICE

(71) Applicant: NIHON KOHDEN CORPORATION, Tokyo (JP)

(72) Inventors: Shohei TADA, Tokorozawa-shi (JP); Taku SUZUKI, Tokorozawa-shi (JP); Naohiro OKAMOTO, Tokorozawa-shi (JP)

(73) Assignee: NIHON KOHDEN CORPORATION, Tokyo (JP)

(21) Appl. No.: 18/923,054

(22) Filed: Oct. 22, 2024

(30) Foreign Application Priority Data
Oct. 30, 2023 (JP) 2023-185854

(51) Int. Cl. G06F 21/32

(52) U.S. Cl. CPC G06F 21/32

(57) ABSTRACT

A physiological information processing system includes a first information processing device configured to process physiological information, a second information processing device, and a relay device configured to control network communication between the first information processing device and the second information processing device. The relay device includes a controller configured to set network information of the first information processing device as network information of the relay device.

### CROSS-REFERENCE TO RELATED APPLICATIONS

This application is based on and claims priority under 35 USC 119 from Japanese Patent Application No. 2023-185854 filed on Oct. 30, 2023, the entire content of which is incorporated herein by reference.

### TECHNICAL FIELD

The presently disclosed subject matter relates to a physiological information processing system and a relay device.

### BACKGROUND ART

In a medical institution, various information devices including a medical device are used while cooperating with each other in a network environment. Since the medical device is used on a human body, safe system management is required in the network environment.

For example, U.S. Pat. No. 11,558,261B discloses a management system that gives a notification of alarm information when a specific event such as incorrect password input occurs in an encryption protocol for network communication of the medical device.

In recent years, laws and regulations require strengthening the network security of the medical device against an external cyber attack. Specifically, three requirements (confidentiality, authenticity, and integrity) are required for the medical device. In order to meet these requirements, it is necessary to encrypt a packet to prevent wiretapping of communication data or the like and to strengthen the network security.

### SUMMARY OF INVENTION

Aspect of non-limiting embodiments of the present disclosure relates to to provide a physiological information processing system and a relay device with enhanced network security.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a physiological information processing system including:
a first information processing device configured to process physiological information;
a second information processing device; and
a relay device configured to control network communication between the first information processing device and the second information processing device,
in which the relay device includes a controller configured to set network information of the first information processing device as network information of the relay device.

According to an aspect of the present disclosure, there is provided a relay device for relaying network communication between a first information processing device and a second information processing device, the first information processing device being configured to process physiological information, the relay device including:
a controller configured to set network information of the first information processing device as network information of the relay device.

### BRIEF DESCRIPTION OF DRAWINGS

Exemplary embodiment(s) of the present invention will be described in detail based on the following figures, wherein:

FIG. 1 is a configuration diagram of a physiological information processing system according to an embodiment of the presently disclosed subject matter;

FIG. 2 is a block diagram of a relay device;

FIG. 3 is a configuration diagram of a communication packet; and

FIG. 4 is a schematic diagram of a user operation screen for setting encryption.

### DESCRIPTION OF EMBODIMENTS

Hereinafter, an embodiment of the presently disclosed subject matter will be described with reference to the drawings.

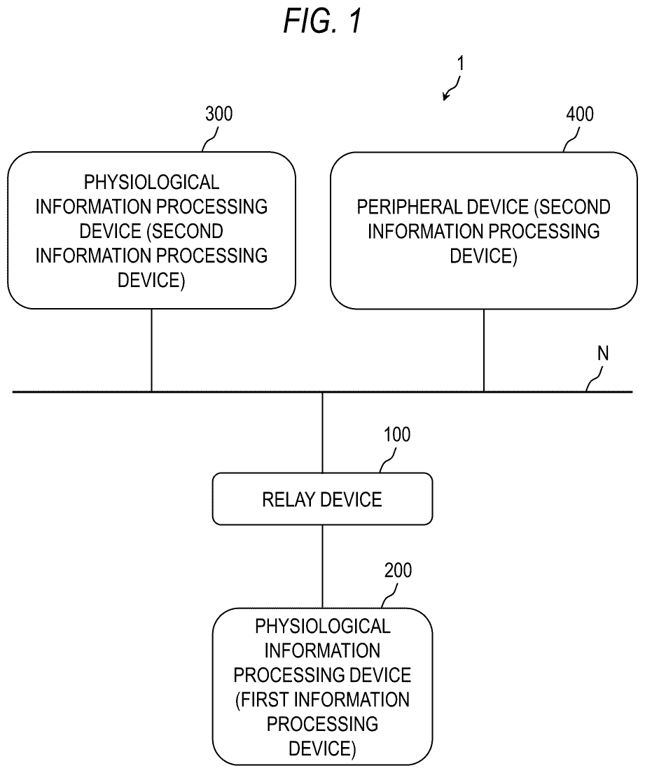

FIG. 1 is a configuration diagram of a physiological information processing system according to an embodiment of the presently disclosed subject matter. As illustrated in FIG. 1, a physiological information processing system 1 can include a relay device 100, physiological information processing devices 200 and 300, and a peripheral device 400. The physiological information processing device 300 and the peripheral device 400 are directly connected to a network N, and the physiological information processing device 200 is connected to the network N via the relay device 100. The network N is, for example, a local area network (LAN), and is implemented by one or both of wired and wireless networks. The communication protocol of the network N may be a general-purpose communication protocol such as transmission control protocol/Internet protocol (TCP/IP), or may be a communication protocol dedicated to the medical field such as digital imaging and communications in medicine (DICOM). In the transport layer, encrypted communication protocols such as secure sockets layer/transport layer security (SSL/TLS) and datagram transport layer security (DTLS) are used. The physiological information processing devices 200 and 300 and the peripheral device 400 are configured to transmit and receive communication packets to and from each other using any one of unicast, multicast, and broadcast communication methods.

The physiological information processing devices 200 and 300 are, for example, central monitors, bedside monitors, central units, medical telemeters, and the like, and are medical devices configured to process physiological information. The peripheral device 400 is, for example, a printer, a server, or the like, and is not a medical device. Hereinafter, the physiological information processing device 200 is also referred to as a first information processing device, and the physiological information processing device 300 and the peripheral device 400 are collectively referred to as a second information processing device. In this example, the second information processing device has a configuration that can include the physiological information processing device 300 and the peripheral device 400, and may have a configuration that can include only one of the physiological information processing device 300 and the peripheral device 400. In this example, the physiological information processing device 300 and the peripheral device 400 are each connected to the network N. Alternatively, a plurality of physiological information processing devices 300 may be connected to the network N, or a plurality of peripheral devices 400 may be connected to the network N. The relay device 100 is a relay configured to control network communication between the first information processing device and the second information processing device. In a case where the first information processing device does not include a monitoring system that relates to encryption and decryption of a communication packet, the relay device 100 has a function as the system.

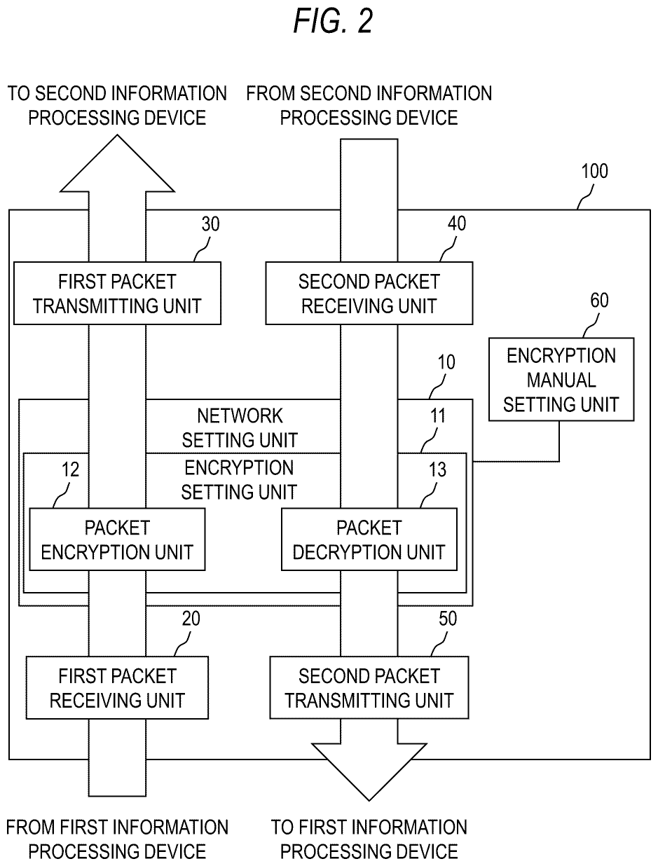

FIG. 2 is a block diagram of the relay device 100. The relay device 100 can include a network setting unit 10, a first packet receiving unit 20, a first packet transmitting unit 30, a second packet receiving unit 40, a second packet transmitting unit 50, and an encryption manual setting unit 60. The network setting unit 10 can include an encryption setting unit 11. The encryption setting unit 11 can include a packet encryption unit 12 and a packet decryption unit 13. The relay device 100 may include a central processing unit (CPU), a read only memory (ROM), a random access memory (RAM), a hard disk drive (HDD), and the like. The CPU may function as a network setting unit 10, a first packet receiving unit 20, a first packet transmitting unit 30, a second packet receiving unit 40, a second packet transmitting unit 50, an encryption setting unit 11, a packet encryption unit 12, and a packet decryption unit 13.

The first packet receiving unit 20 is configured to receive a communication packet from the physiological information processing device 200, which is the first information processing device. The first packet transmitting unit 30 is configured to transmit the communication packet received by the first packet receiving unit 20 to at least one of the physiological information processing device 300 and the peripheral device 400, which are the second information processing device. The second packet receiving unit 40 is configured to receive the communication packet from at least one of the physiological information processing device 300 and the peripheral device 400. The second packet transmitting unit 50 is configured to transmit the communication packet received by the second packet receiving unit 40 to the physiological information processing device 200.

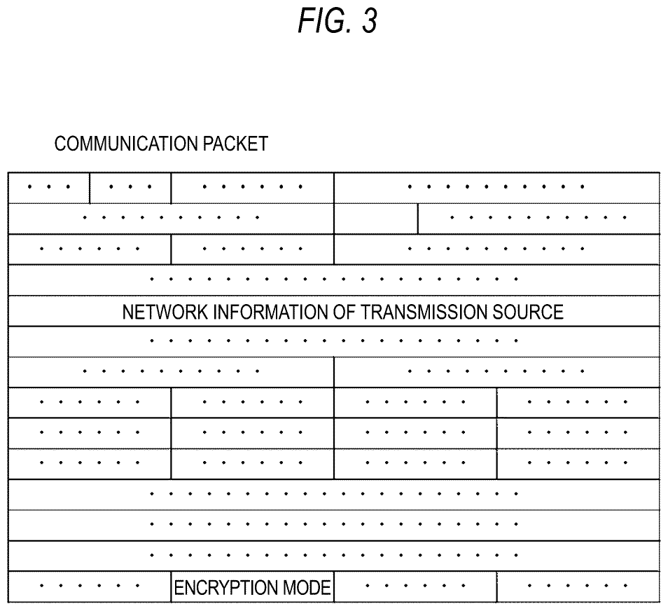

Here, a configuration diagram of a communication packet will be described with reference to FIG. 3. The communication packets transmitted by the first information processing device and the second information processing device are implemented by a plurality of fields.

As illustrated in FIG. 3, one field of the communication packet includes the network information of the first information processing device which is a packet transmission source. The network information represents, for example, a MAC address or an IP address of the first information processing device.

As illustrated in FIG. 3, other fields of the communication packet include the encryption mode information of the packet transmission source (the first information processing device or the second information processing device). The encryption mode information indicates whether the packet transmission source supports the encrypted packet. The encryption mode information has, for example, a first mode that supports the non-encrypted packet and that does not support the encrypted packet, a second mode that supports the encrypted packet and the non-encrypted packet, and a third mode that supports the encrypted packet and that does not support the non-encrypted packet. In a case where the device of the packet transmission source is in the first mode, when the device of the packet transmission destination is in the first mode or the second mode, communication is executed using the non-encrypted packet, and when the device of the packet transmission destination is in the third mode, no packet communication is executed. In a case where the device of the packet transmission source is in the second mode, when the device of the packet transmission destination is in the first mode, communication is executed using the non-encrypted packet, and when the device of the packet transmission destination is in the second mode or the third mode, communication is executed using the encrypted packet. In a case where the device of the packet transmission source is in the third mode, when the device of the packet transmission destination is in the second mode or the third mode, communication is executed using the encrypted packet, and when the device of the packet transmission destination is in the first mode, no packet communication is executed. The encryption mode information May be included in the field in the body of the communication packet, or may be included in the field in the header.

The description returns to FIG. 2. The network setting unit 10 is configured to refer to the communication packet from the first information processing device received by the first packet receiving unit 20, and to obtain the network information of the first information processing device. Further, the network setting unit 10 is configured to set the obtained network information of the first information processing device as the network information of the relay device 100. In other words, the network setting unit 10 is configured to clone the network information of the first information processing device to the network information of the relay device 100. Accordingly, the relay device 100 and the second information processing device can execute packet communication as if the first information processing device and the second information processing device directly execute packet communication. Therefore, the relay device 100 can execute encrypted packet communication instead of the first information processing device.

The encryption setting unit 11 is configured to refer to the communication packet from the first information processing device received by the first packet receiving unit 20, and to obtain the first encryption mode information. The encryption setting unit 11 is configured to set the first encryption mode, which is the encryption mode of the packet transmitted by the first packet transmitting unit 30, based on the obtained first encryption mode information. Here, the encryption setting unit 11 is configured to set the first mode that does not support the encrypted packet, the second mode that supports the encrypted packet and the non-encrypted packet, and the third mode that supports the encrypted packet and that does not support the non-encrypted packet.

The encryption setting unit 11 is configured to refer to the communication packet from the second information processing device received by the second packet receiving unit 40, and to obtain the second encryption mode information. The encryption setting unit 11 is configured to set the second encryption mode, which is the encryption mode of the packet transmitted by the second packet transmitting unit 50, based on the obtained second encryption mode information. Here, the encryption setting unit 11 is configured to set the first mode to the third mode, as in the case of the first encryption mode information.

After the network setting unit 10 sets the network information of the first information processing device as the network information of the relay device 100, the packet encryption unit 12 encrypts the non-encrypted packet transmitted from the first information processing device, based on the first encryption mode and the second encryption mode that are set by the encryption setting unit 11. Accordingly, for example, when the first information processing device is in the first mode in which the encrypted packet cannot be transmitted and the second information processing device is in the third mode in which only the encrypted packet can be received, the relay device 100 encrypts the non-encrypted packet instead of the first information processing device, and transmits the encrypted packet to the second information processing device, thereby enabling the encrypted packet communication.

After the network setting unit 10 sets the network information of the first information processing device as the network information of the relay device 100, the packet decryption unit 13 decrypts the encrypted packet transmitted from the second information processing device, based on the first encryption mode and the second encryption mode that are set by the encryption setting unit 11. Accordingly, for example, when the first information processing device is in the first mode in which the encrypted packet cannot be decrypted and the second information processing device is in the third mode in which only the encrypted packet can be transmitted, the relay device 100 decrypts the encrypted packet instead of the first information processing device, and transmits the decrypted packet to the first information processing device, thereby enabling the encrypted packet communication.

After the network link is established, the first information processing device and the second information processing device periodically receive the communication packet by broadcast in order to notify other devices of the own device information and operating state. Therefore, it is preferable that at least one of the first encryption mode and the second encryption mode is included in the broadcast communication packet so that the relay device 100 can execute initial setting and update setting of the encryption mode of the first information processing device and the second information processing device at an appropriate timing.

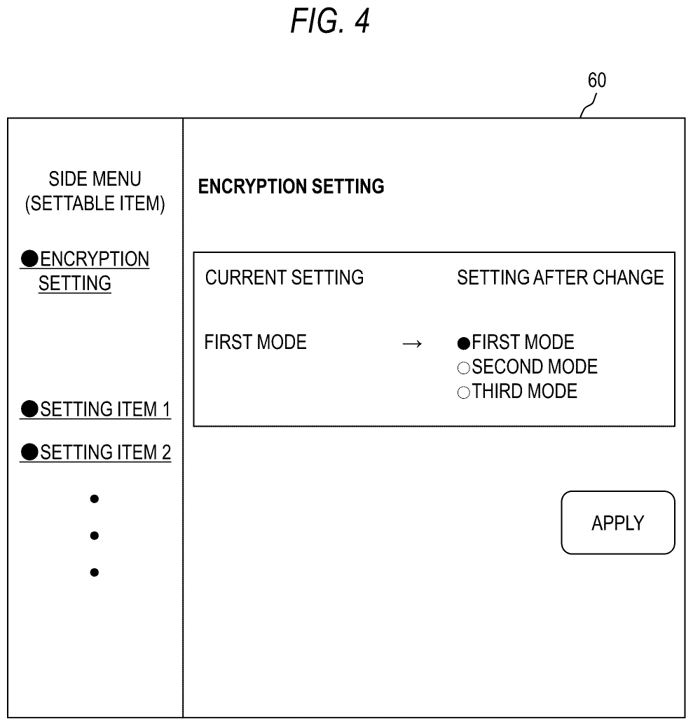

The encryption manual setting unit 60 is an interface configured to allow the user to set the encryption mode (the first mode to the third mode) of the first information processing device. Specifically, as illustrated in FIG. 4, the encryption mode of the first information processing device can be set or changed by a radio button method or the like on a user operation screen for setting encryption. The packet encryption unit 12 is configured to encrypt the non-encrypted packet transmitted from the first information processing device, based on the encryption mode set in the encryption manual setting unit 60. In a case where the first encryption mode is set based on the first encryption mode information and the encryption mode is set by the encryption manual setting unit 60, the packet encryption unit 12 may preferentially execute packet encryption based on the encryption mode set in the encryption manual setting unit 60.

As described above, the physiological information processing system and the relay device according to the embodiment of the presently disclosed subject matter can enable, by encrypting or decrypting the communication packet in the relay device, pseudo-encrypted communication even for the information processing device that does not support encrypted communication. Accordingly, it is possible to prevent wiretapping of communication data or the like and to strengthen the network security.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The processing of the physiological information processing system 1 according to the present embodiment can be implemented as a computer program that operates in the relay device 100. That is, the relay device 100 can include a processor such as a CPU and a memory.

The program is stored in a non-transitory computer-readable medium and can be read by a computer. Examples of the non-transitory computer-readable medium include a magnetic recording medium, a magneto-optical recording medium, a CD-ROM, a CD-R, a CD-R/W, and a semi-conductor memory (including an EPROM and a flash ROM). The program may be read by a computer using various types of temporary computer-readable media. Examples of the temporary computer-readable medium include an electric signal, an optical signal, and an electromagnetic wave. The temporary computer-readable medium can supply a program to the computer via a wired communication path such as an electric wire and an optical fiber or a wireless communication path.

What is claimed is:

1. A physiological information processing system comprising:
a first information processing device configured to process physiological information;
a second information processing device; and
a relay device configured to control network communication between the first information processing device and the second information processing device,
wherein the relay device includes a controller configured to set network information of the first information processing device as network information of the relay device.

2. The physiological information processing system according to claim 1,
wherein after the controller sets the network information of the first information processing device as the network information of the relay device, the relay device encrypts a packet transmitted from the first information processing device and transmits the encrypted packet to the second information processing device.

3. The physiological information processing system according to claim 1,
wherein after the controller sets the network information of the first information processing device as the network information of the relay device, the relay device decrypts a packet transmitted from the second information processing device and transmits the decrypted packet to the first information processing device.

4. The physiological information processing system according to claim 1,
wherein the controller is configured to set an encryption mode of a packet that the relay device transmits, based on encryption mode information included in a packet transmitted from the second information processing device.

5. The physiological information processing system according to claim 4,
wherein the controller is configured to set:
a first mode that does not support an encrypted packet and that supports a non-encrypted packet;
a second mode that supports the encrypted packet and that supports the non-encrypted packet; or
a third mode that supports the encrypted packet and that does not support the non-encrypted packet.

6. The physiological information processing system according to claim 1,
wherein the second information processing device is configured to process physiological information.

7. A relay device for relaying network communication between a first information processing device and a second information processing device, the first information processing device being configured to process physiological information, the relay device comprising:
a controller configured to set network information of the first information processing device as network information of the relay device.
